(19) United States
(12) Patent Application Publication
(10) Pub. No.: US 2026/0208124 A1
(43) Pub. Date: Jul. 23, 2026

(54) MATERIAL

(71) Applicant: WATERCYCLE TECHNOLOGIES LIMITED, Manchester (GB)

(72) Inventors: Sebastian James Allender LEAPER, Manchester (GB); Ahmed ABDELKARIM, Manchester (GB)

(21) Appl. No.: 19/139,636

(22) PCT Filed: Dec. 13, 2023
(86) PCT No.: PCT/EP2023/085658

§ 371 Date: Jun. 16, 2025

(30) Foreign Application Priority Data
Dec. 14, 2022 (GB) 2218891.6

(51) Int. Cl. B01D 69/14; B01D 67/00; B01D 69/02; B01D 69/08; B01D 71/68; B01J 39/02; B01J 39/09; B01J 47/12; C22B 3/42; C22B 26/12

(52) U.S. Cl. CPC B01D 69/1411; B01D 67/00793; B01D 69/02; B01D 69/08; B01D 71/68; B01J 39/02; B01J 39/09; B01J 47/12; C22B 3/42; C22B 26/12; B01D 2325/04

(57) ABSTRACT

Described is a lithium-ion exchange material for direct lithium extraction, comprising a polyethersulfone matrix material; and, within the matrix, lithium titanium oxide and/or hydrogen titanium oxide derived from lithium titanium oxide. Also described is a method of performing direct lithium extraction utilising such a material.

### FIELD OF THE INVENTION

The present invention relates to materials, in particular membranes, for use in direct lithium extraction.

The invention further relates to the use of such membranes.

### BACKGROUND

Lithium hydroxide (specifically, lithium hydroxide monohydrate) is one of two main forms of lithium used for the production of lithium ion batteries. The demand for lithium hydroxide is growing exponentially due to the increased demand for electric vehicles. However, the production of lithium hydroxide requires energy-intensive electrolytic methods or additional precipitation steps compared to the second main form, lithium carbonate.

Direct Lithium Extraction (DLE) is a process involving the selective extraction of lithium from aqueous sources such as natural brines, seawater or industrial wastewaters. This can be achieved in various ways including adsorption, ion exchange, electrodialysis, nanofiltration or others.

Of these, ion exchange represents an energy-efficient process that is driven by adjustments in pH rather than applied pressure or electrical current. When flowing a lithium-containing feedstock solution such as brine through lithium-selective ion exchange media, lithium ions migrate into the selective media (that is, are extracted or leeched from the feedstock), leaving other components in the feedstock, to replace ions already present. Once the lithium has been taken up by the media, the remaining feedstock can be removed. By then flowing a dilute acid solution through the media, protons from the acid exchange with the lithium ions held in the media (releasing the lithium ions into the solution). The lithium-rich solution that is created from this process can then undergo further concentration and crystallisation stages to produce salts such as lithium hydroxide or lithium carbonate. These two salts are the main form of lithium used in the manufacture of lithium-ion batteries.

Such lithium-selective ion exchange media are sometimes referred to as Lithium-Ion Sieves (LISs).

In practice, LIS materials may not always be suitable for use alone; for example, they may be difficult to handle or have poor durability. Therefore, the materials used often comprise not only a chemical compound which can perform the ion exchange process mentioned above (the ‘selective material’), but also a matrix material which carries (or has embedded in it) the selective material. This matrix material often enables more complex physical structures. This is advantageous as the selective materials themselves may have poor physical properties in the pure form; mixing with a matrix material increases strength and resistance to wear.

A key consideration when producing a material for lithium extraction is therefore the choice of these two components.

In the case the selective material (LIS), there are many suitable candidates. These include metal organic frameworks, zeolites, layered double hydroxides or lithium metal oxides such as lithium manganese oxide (LMO).

[It will be recognised that, of course, during the ion exchange reaction a compound such as lithium manganese oxide (LMO) will be converted, to at least some degree, to hydrogen manganese oxide (HMO); it will convert back when it leeches lithium ions from a suitable feedstock.] LMO/HMO suffers from loss of manganese over time due to its dilution in acidic solutions. Such conditions are of course necessary for the removal of lithium from the LIS (to affect the proton ion exchange) and hence LMO/HMO has a significant drawback in such applications.

For the matrix material, chemical and thermal stability are important, as are other factors such as cost. It is important to have broad stability for withstanding the chemical diversity of lithium brines as well as the pH swings inherent in the lithium extraction process described above. Ceramic matrix materials have excellent chemical and thermal stability but suffer from high cost of manufacture. Polymers are generally lower in cost compared to their ceramic counterparts but can suffer from lower chemical and thermal stability.

CN109225121A discusses membranes comprising lithium manganese oxide and polyacrylonitrile as a LIS for use in DLE.

Accordingly there remains a need for improved adsorption or ion-exchange media.

The present invention has been devised in the light of the above considerations.

### SUMMARY OF THE INVENTION

The present inventors sought to provide an improved material for DLE, specifically one suitable for use with geothermal lithium-containing brines. Proposed herein is a material comprising lithium titanate (lithium titanium oxide, LTO), or precursors thereof (such as hydrogen titanium oxide, HTO, derived from LTO) as a selective material along with polyethersulfone (PES) as a matrix material.

Accordingly, in a first aspect, the invention may provide a lithium-ion exchange material for direct lithium extraction, comprising
(i) a polyethersulfone matrix material; and, within the matrix,
(ii) lithium titanium oxide and/or hydrogen titanium oxide derived from lithium titanium oxide.

It will be understood here that “hydrogen titanium oxide”, HTO, may have slightly different structure depending on the compound from which it was derived. For example, when LTO is the starting material, its Li ions can be exchanged for protons by contact with a protic acid as described herein. The resultant HTO has ‘gaps’ in which the protons sit which are suitably spaced to receive Li ions. Hence, that LTO-derived HTO can act as a selective sieve/adsorbent material for Li ions.

In some embodiments the lithium titanium oxide or hydrogen titanium oxide derived from LTO (whichever is present, in whatever amount) is particulate; that is, the lithium-ion exchange material comprises (ii) particulate lithium titanium oxide and/or particulate hydrogen titanium oxide).

The particles may suitably have an average (D₅₀) particle size, as measured by SEM, of ≤50 μm, suitably≤25 μm, or ≤10 μm. Most suitable is a particle size of ≤5 μm, for example about 2-3 μm. In some embodiments a smaller particle size may be preferred in order to increase the available LTO/HTO surface area for ion exchange.

The inventors have found that this combination of selective material and matrix material is highly effective at selectively extracting lithium from a lithium-containing feedstock, while being resistant to both extraction conditions (e.g. elevated pH/alkaline conditions, elevated temperature) and release conditions (e.g. reduced pH/acidic conditions).

In particular, the inventors have found that the titanate compounds do not suffer from the drawback of LMO/HMO, dissolution and hence loss of the LMO/HMO into the acidic release solution. The titanium compounds of the present invention form bonds to the PES matrix and have improved longevity as compared to their manganese-based counterparts.

This chemical stability allows the claimed combination to withstand the variety of chemical conditions applied through the DLE process, for example the chemical diversity of lithium brines and the pH swings described herein.

Furthermore, the inventors have found that PES loaded with LTO/HTO in this way is stable at elevated temperatures, for example above around 80° C. (in fact the high glass transition temperature of PES enables it to be operated at up to around 200° C.). This opens up the possibility of DLE from hot feedstocks such as brine from geothermal sources (geothermal brine), which generally has a temperature of around 65-70° C. It also enables the lithium extraction step of the process to be conducted at elevated temperatures, which leads to faster lithium uptake rates.

The present lithium ion-exchange material may preferably be provided in the form of a membrane. Such a membrane might be a simple flat sheet (e.g. cast) membrane, or have a more complex structure such as that of a hollow fiber. Hollow fiber membranes have been found by the inventors to have several advantages in DLE processes; in particular, a high useful surface area especially where the feedstock is flown in contact with the lithium ion-exchange material. Such hollow fibers are known in the art of water treatment; they are elongate, generally extruded members with a bore (hollow part) inside the substantially circular cross-section fiber.

A hollow fiber morphology of the material may be preferable as a feedstock brought into contact with the fiber has surface contact with a large active area. Hollow fibers can also be packed into a housing to form a membrane module; flow of feedstock through the module again allows high surface contact and hence efficient lithium extraction and release.

Suitable hollow fiber dimensions will be apparent to those skilled in the art. For example, a hollow fiber length of 0.2-2 m, an outer diameter of 0.4-5 mm, and a wall thickness of 10-200 μm may be used.

The hollow fibers themselves may have, for example, a length of about 1 m, an outer diameter of about 1 mm, and an inner (bore) diameter of about 0.9 mm.

Within the present lithium ion-exchange material, the content of the LTO/HTO derived from LTO is suitably about 20-50% by mass. The content of PES is suitably about 50-80% by mass (or 100% minus the content of the LTO/HTO derived from LTO). The content of the LTO/HTO derived from LTO by mass may in some embodiments be about 25-100%, suitably about 50%, the content of the PES by mass.

For example, the lithium ion-exchange material may include about ⅓ by mass of LTO/HTO and about ⅔ by mass of PES.

Such contents are found to give a good balance of mechanical properties and extraction efficiency.

In a second aspect, the present invention provides a method of direct lithium extraction from a lithium-containing feedstock solution, the method comprising:
(i) an extraction step, in which the lithium-containing feedstock solution is contacted with a lithium ion-exchange material, whereby the lithium ion-exchange material is loaded with lithium ions; and
(ii) a release step, in which a release solution comprising a protic acid is contacted with the lithium ion-exchange material, whereby lithium ions are released from the lithium ion-exchange material into the release solution;
wherein the lithium ion-exchange material is as set out in the first aspect and as discussed herein.

In the extraction step, a lithium-containing feedstock has lithium ions ‘removed’ from it by the lithium ion-exchange material. Those are replaced by, generally, protons. This extraction step is therefore characterised as a first ion exchange. Before it, the lithium ion-exchange material may suitably be mainly in the form of HTO. Through extraction of lithium from the feedstock, it is at least partially converted to LTO.

In the release step, a release solution including a protic acid is used to perform the equivalent ion exchange, in reverse. That is, protons from the release solution exchange with lithium ions in the LTO, converting it back to HTO and releasing the lithium ions into the release solution.

The lithium-enriched release solution can then be further processed to remove the lithium, generally in salt form.

The depleted feedstock is suitably removed after the extraction step. It may then be, for example, subject to further processing; or recycled back into the feed to act as a ‘new’ feedstock for lithium ion extraction.

A single aliquot of feedstock may be subject to the above extraction and release steps multiple times (cycles), gradually reducing the lithium content each time.

In some embodiments, after the depleted feedstock is removed, there is a first washing step in which the lithium ion-exchange material is washed with water (suitably deionised water). The first washing step may be conducted for, for example, about 10-120 minutes.

In the extraction step, it will be appreciated that the desired ion exchange (lithium in the feedstock switching with protons in the lithium ion-exchange material) can be driven by using a feedstock of raised pH (i.e. a proton-poor environment). Therefore, the feedstock used in the extraction step may suitably have a pH of greater than 7, for example greater than 8 or greater than 9. This may be achieved in a step, before the extraction step, of increasing the pH of the feedstock by addition of an alkaline solution or basic compound, for example NaOH, in the amount required to raise the pH to the desired level.

The extraction step may suitably be conducted at a temperature above room temperature, for example around 25-70° C., suitably 50-70° C. Where geothermal brines are used as the feedstock, they are often naturally of elevated temperature (for example about 40-70° C.) and hence the extraction step necessarily proceeds at above room temperature where such a feedstock is used directly from the ground source.

In the release step, it will similarly be appreciated that the desired ion exchange (lithium in the lithium ion-exchange material switching with protons in the release solution) can be driven by using a release solution of reduced pH (i.e. a proton-rich environment); hence the inclusion of protic acid in the release solution. The release solution may suitably have a pH of less than 7, for example less than 6 or less than 5.

For example, a suitable choice of release solution is an acidic solution such as citric acid or oxalic acid, for example a 0.2 M citric acid solution. With such a release solution, after the release step a lithium citrate solution is obtained. This can be processed to extract lithium citrate (for example by crystallisation, precipitation etc.). Lithium citrate can then be processed to form, for example, lithium hydroxide.

Alternatively, the lithium citrate solution itself can be processed to directly form lithium hydroxide, for example by addition of a suitable metal hydroxide (such as barium hydroxide) to generate barium citrate, which precipitates, leaving a lithium hydroxide solution.

The release step may suitably be conducted at a temperature above room temperature, for example around 25-70° C., suitably 50-70° C.

The invention includes the combination of the aspects and preferred features described except where such a combination is clearly impermissible or expressly avoided. For example, preferences and features of the lithium ion-exchange material expressed with respect to the first aspect apply equally when that material is employed in the method of the second aspect.

### SUMMARY OF THE FIGURES

Embodiments and experiments illustrating the principles of the invention will now be discussed with reference to the accompanying figures in which:

FIG. 1. shows the lithium uptake performance of membranes of the present invention over seven cycles of lithium extraction.

FIG. 2. shows the mean impurity rejection values of membranes of the present invention for Ca²⁺, Na⁺, Mg²⁺ and K⁺ ions over seven cycles of lithium extraction.

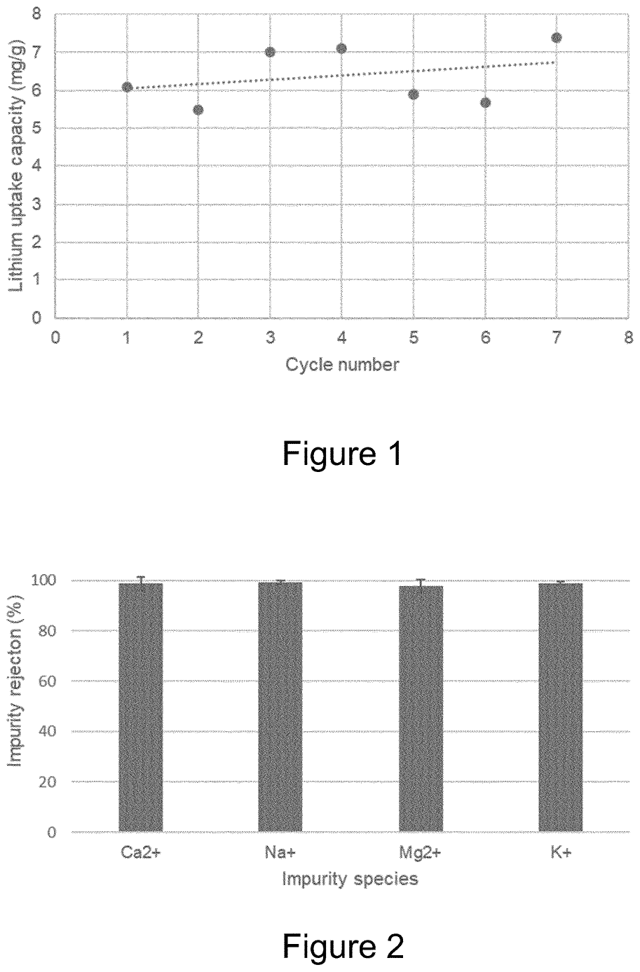

### DETAILED DESCRIPTION OF THE INVENTION

Aspects and embodiments of the present invention will now be discussed in more detail. Further aspects and embodiments will be apparent to those skilled in the art. All documents mentioned in this text are incorporated herein by reference.

### Direct Lithium Extraction

Direct lithium extraction (DLE) is a process where lithium is selectively extracted from impure solutions containing large amounts of multiple ionic species, wherein the majority of other components are left in solution. There are a number of DLE techniques known in the art, including electrodialysis, nanofiltration, adsorption and ion-exchange. The latter two approaches hold the most promise in terms of lithium selectivity, energy consumption and cost. DLE represents an alternative to conventional lithium brine extraction processes which utilise successive crystallisation stages (often with the use of evaporation ponds) which remove impurity compounds such as sodium chloride and leave the lithium in solution.

General DLE methods are well known in the art and will not be discussed in great detail here.

For example, adsorption and ion-exchange processes typically involve a material which has selective affinity for lithium over other ions. During operation, typically a lithium-containing solution is contacted with the selective material, often with its pH slightly raised (that is, pH>7; optionally the pH may be raised yet higher, for example>8, >9, >10 or >11). The raising of the pH may be done by adding any suitable chemical agent (for example, any base).

Suitable bases used to adjust the pH of the feedstock solution are not particularly limited as the lithium ion sieve is highly selective for lithium ions. Suitable bases include NaOH, KOH, NaCO₃, KCO₃, NaHCO₃, KHCO₃, NH₄OH, ammonium carbonate, ammonium persulfate, ammonia, Ca(OH)₂ and Ba(OH)₂ (and their associated oxides). In terms of cost, NaOH is preferred.

For example, the selective material may be provided as beads in a column, with the feedstock poured into/through the column; or it may be provided in the form of hollow fibers, with the feedstock fed through or over the fibers. This facilitates the uptake of the lithium and replaces protons in the material. This initial contact, removing the lithium from the feedstock and ‘storing’ it in the selective material, can be termed an ‘extraction step’ of the DLE process.

The extraction step, as well as suitably being conducted at raised pH, may also or instead suitably be conducted at raised temperature (that is, >room temperature; for example>30° C., >40° C., >50° C., >60° C. or >70° C.).

A temperature of 25-70° C., and particularly 50-70° C., may be preferred,

The length of time for which there is contact between the feedstock and the selective material depends on several factors, for example how the selective material is provided. If it is provided in fibers, or a column, through which a feedstock is flown, the rate of flow is important. If the selective material is simply placed in contact with a stationary feedstock for some length of time, the time it is left is the relevant feature.

In some embodiments, the extraction step may be conducted for 10-150 minutes.

After a given time, the de-lithiated feedstock is suitably removed from contact with the selective material, and the selective material may be rinsed with fresh water. This can remove any impurities loosely bound to the lithium ion-exchange material, before the release step is carried out.

In order to release the lithium from the selective material, a protic acidic solution (release solution) is introduced; this replaces the lithium ions with protons. The lithium is released from the selective material, forming a lithium-rich solution which can be removed for further processing. This can be termed a ‘release step’ of the DLE process.

A typical acid used to release the lithium ions is HCl. When HCl is contacted with the selective material, lithium ions are removed from it and a solution is formed that comprises lithium chloride (typically with small amounts of impurities).

This lithium chloride solution can then be converted into industrially useful materials such as lithium hydroxide and lithium carbonate at a later stage.

Similar processes occur when other acids are used. Suitable acids include citric acid, sulfuric acid, hydrochloric acid, phosphoric acid, ascorbic acid and oxalic acid. Citric acid may be preferable as it is a relatively easily obtainable, low toxicity acid which provides lithium citrate solutions that are readily processed.

The pH of the release solution (which is generally aqueous) depends of course on the acid included in it and how much is included; generally, it has a pH<7, for example<6, <5, <4, or <3.

The release step may suitably be conducted at up to 70° C. A temperature above room temperature, for example around 25-70° C., suitably 50-70° C., may be preferred. Higher temperatures are positively associated with Lit deintercalation from the LTO/HTO system.

### Selective Material

The DLE process requires the selective ion exchange of lithium ions to and from a material.

In order to conserve charge, clearly, in order to desorb (release) the lithium ions they must be replaced with a suitable cation; this is often a proton as suitable protic acidic solutions are readily available.

Similarly, using basic solutions encourages the adsorption (take up) of lithium from solution, by removing protons from the lithium-ion sieve material. By varying pH, the selective ‘adsorption’ (take up) and ‘desorption’ (release) of lithium can be carefully controlled. A more basic feedstock solution provides the fastest lithium extraction rate; a more acidic release solution provides the fastest lithium release rate. However, rate must also be balanced against other factors such as acid/base safety and toxicity, additional cost and so on.

In the present invention, the selective material is a titanium-based compound. In particular, it is lithium titanate or a precursor compound which can be converted to lithium titanate in situ. An example of such a precursor is hydrogen titanium oxide (in particular HTO which is itself derived from LTO), which is converted to lithium titanate through exposure to a suitably basic (pH>7) solution containing lithium.

Lithium titanate (lithium titanium oxide, LTO) is available in many forms including lithium titanate spinel (LiₓTi₅O₁₂, wherein 4≤x≤7), lithium metatitanate (Li₂TiO₃), lithium orthotitanate (Li₄TiO₄), and ramsdellite lithium titanate (Li₂Ti₃O₇). In the present invention, Li₂TiO₃ is preferred.

Hydrogen titanium oxide (titanic acid, HTO) is available in many forms including H₂TiO₃.

Intermediate titanium-containing compounds can also be used containing both lithium and hydrogen. It will be appreciated that a given ‘molecule’ will transitions through several such compound states, as well as potentially ‘pure’ LTO and ‘pure’ HTO states, during a cycle (extraction+release) of the DLE process.

The selective material may suitably be provided in the form of particles.

In some embodiments, the particle size of the selective material is ≤50 μm, suitably≤25 μm, or ≤10 μm. Most suitable is a particle size of ≤5 μm, or ≤3 μm.

On the other hand, the particles may suitably have a size of ≥200 nm, for example≥400 nm, ≥1 μm, or ≥2 μm.

It will be appreciated that, as extraction and release steps of the DLE process occur, a range of LTO/HTO/intermediate compounds may be present, to varying degree, depending on the effective loading or unloading of lithium in the selective material. There is no particular need that the extraction step proceed until all protons in HTO have been replaced with lithium; similarly, no need for the release step to proceed until all lithium in the selective material has been replaced with protons.

Before the extraction step, the selective material may be subjected to a priming step, wherein it (especially, LTO contained within it) is contacted with a priming solution (which may have the same properties as the release solution discussed herein, especially it may be a protic acid). This extracts lithium ions from the LTO, leaving spaces which are filled with protons from the priming solution. This generates HTO (derived from LTO). Then, during the extraction step, the HTO (derived from HTO) selectively ion exchanges its protons for lithium ions from the feedstock. The spaces remain the right size for lithium ions because of the LTO-derivation of the HTO; accordingly HTO derived from LTO can act as a selective sieve or adsorbent for lithium ions.

### Matrix Material

As the selective material alone commonly does not have suitable physical properties to be used directly in the DLE process, it is usually the case that the selective material is compounded with a matrix material to improve its strength, handleability and the like. Herein, this combination (selective material and matrix material) is referred to as the lithium ion-exchange material.

The selective material may be held in the matrix material, for example bonded to it. In the present invention, polyethersulfone (PES) is used as the matrix material. The selective material may be dispersed in the PES polymer matrix. The inventors postulate that a coordination bond between the titanium atom in LTO/HTO and the PES can form, giving a strong immobilisation of the LTO/HTO material. This increases its resilience to ‘erosion’ during the DLE process, be that by chemical or physical means. PES is also stable at increased temperatures, such as those that might be encountered if a hot feedstock such as geothermal brine is used.

PES is available in many molecular weights, the average molecular weight of the polyethersulfone used in the present invention is not particularly limited. In some embodiments, the average molecular weight of the PES is between 10 kDa and 500 kDa, preferably between 25 kDa and 100 kDa, more preferably around 50 kDa.

The PES matrix is suitably porous; this increases the flow of the feedstock to the selective material (which may not necessarily be present on the outer surface of the matrix material) and facilitates transfer of lithium ions. The pores effectively increase the active surface area of the material. Accordingly larger pores, for example of an average pore size 0.1-2 μm, for example 0.5-1 μm, are preferable.

For the present lithium ion-exchange material, a porosity of >60% may be suitable, in particular ≥70%. A porosity of about 80% may be particularly suitable. The pores may have a size (D₅₀) of ≤2 μm, optionally≤1 μm, optionally≤500 nm, optionally≤100 nm, optionally≤50 nm. A pore size of 10-40 nm may be particularly suitable.

Membrane porosity is measured by the known gravimetric method. In detail, the dried membranes were immersed in deionised water for 24 h at room temperature. Thereafter, samples were carefully taken out, wiped using tissue paper to remove excess water from the surface, and weighed. Afterwards, samples were placed in a vacuum oven at 60° C. for 8 h then weighed. The porosity, &, was calculated using the following equation:

$$ε = \frac{\frac{{W}_{w} - {W}_{d}}{{ρ}_{w}}}{\frac{{W}_{w} - {W}_{d}}{{ρ}_{w}} + \frac{{W}_{d}}{{ρ}_{p}}} \times 100$$

where W_{w} is the weight of the wet membrane, W_{d} is the weight of the dry membrane, ρ_{w} and ρₚ are the density of water and of the polymer, respectively.

Pore size (that is, mean pore radius, rₘ) is measured using the Guerout-Elford-Ferry equation:

$${r}_{m} = \sqrt{\frac{( 2.9 - 1.75 ε ) \times 8 η lQ}{ε A Δ P}}$$

Where ε is porosity, Q is the volume of the permeated pure water per unit time (m³/s), η is the water viscosity (8.9×10⁻⁴ Pa·s at 25° C.) and ΔP is the applied pressure (0.4 MPa), A is the membrane area, I is the membrane thickness.

### Lithium Ion-Exchange Material

As explained above, the present lithium ion-exchange material includes a selective material and a matrix material. It may be provided in various morphologies; for example, it may be formed into beads (for example, substantially spherical beads of average diameter 0.01-10 mm) or, more suitably, into a membrane form.

Such a membrane might be a simple flat (e.g. cast) membrane, or have a more complex structure such as that of a hollow fiber. Hollow fiber membranes have been found by the inventors to have several advantages in DLE processes; in particular, a high useful surface area especially where the feedstock is flown in contact with the lithium ion-exchange material.

Suitable hollow fiber dimensions will be apparent to those skilled in the art. For example, a hollow fiber length of 0.2-2 m (suitably 0.5-1.5 m), an outer diameter of 0.4-5 mm (suitably 0.6-2 mm), and a wall thickness of 10-200 μm (suitably 20-100 μm) may be used.

The hollow fibers themselves may have, for example, a length of about 1 m, an outer diameter of about 1 mm, and an inner (bore) diameter of about 0.9 mm.

Within the present lithium ion-exchange material, the content of the LTO/HTO derived from LTO is suitably about 20-50% by mass. The content of PES is suitably about 50-80% by mass (or 100% minus the content of the LTO/HTO derived from LTO). The content of the LTO/HTO derived from LTO by mass may in some embodiments be about 25-100%, suitably about 50%, the content of the PES by mass.

For example, the lithium ion-exchange material may include about ⅓ by mass of LTO/HTO and about ⅔ by mass of PES.

Methods of making suitable beads or membranes will be apparent to those of skill in the art. Hollow fiber membranes are used often in water treatment technologies; general methods for their fabrication are also well known.

The present inventors have found that such methods are indeed applicable to the LTO/HTO and PES combination now proposed.

For example, PES may be dissolved in a suitable solvent (such as dimethylacetamide) before addition of the selective material. The resultant solution can then be processed into various shape membranes using known methods available to the skilled person such as non-solvent induced phase separation or electrospinning.

The solution resulting from addition of PES and the selective material into the solvent may provide a solution suitable for spinning which comprises from 5 wt % to 30 wt % PES. The solution for spinning may also comprise from 5 wt % to 30 wt % selective material. The solution for spinning may also comprise 40 wt % to 90 wt % solvent.

For example, a solution might be made by mixing 16g of PES with 84g of solvent (such as dimethylacetamide) to form a 100g solution. To this may be added 8g of LTO (i.e. 50% of the PES content by mass), forming a 108g solution containing 16g PES, 84g solvent and 8g LTO.

When solvent is removed in spinning, this leaves a ⅔: ⅓ weight ratio of PES and LTO in the final solid.

***

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### Examples

### Membrane Fabrication

Polyethersulfone pellets (BASF; molecular weight=58 kDa) were dissolved in dimethylacetamide (Sigma) at a concentration of 15 wt/wt % using a magnetic stirrer. Once the polymer was fully dissolved, lithium titanate powder (particle size 2.2 μm; Jinan Future Chemical Industry Co., Ltd.) was added in equal mass to the polymer mass and stirred for 2 hours. The homogeneous polymer solution was then formed into hollow fibre membranes using a two-channel spinneret (outer diameter 2 mm) connected to two syringe pumps (apparatus obtained from TrustTech). The first syringe pump injected the polymer solution at a rate of 2 ml/min and the second syringe pump injected a bore solution comprising a 50 wt % ethanol/water mixture also at a rate of 2 ml/min. The polymer and bore solutions were injected into the spinneret where they formed the hollow fibre structure. This structure then entered a water coagulation bath (at room temperature) which resulted in the solidification of the polymer and the formation of the porous hollow fibre membrane.

### Lithium Extraction Experiments

Lithium extraction experiments were carried out using natural brine from a UK geothermal source (extracted from a site in Cornwall, UK; this brine bears heat and temperature can reach to 70° C.) as the feedstock. To the natural brine, NaOH was added to raise the pH to 9.7. In each experiment, 1 litre of the thus modified brine was placed in a glass vessel along with 2.8 g of hollow fibre membranes fabricated as above. The solution was stirred with a magnetic stirrer and left to adsorb lithium for 2 hours. Following this step, the brine was removed from the vessel and replaced with 500 mL of DI water to rinse of residual ions. This was stirred for 1 hour. Following this, the DI water was removed from the vessel and replaced with 1 L of a 0.2 M citric acid solution as a release solution. This provided the protons necessary to release the lithium ions from the membranes. This release solution was also stirred for 1 hour, resulting in a lithium citrate solution with reduced levels of other ions.

This lithium extraction process was repeated for 7 cycles and analysis of the brines and lithium solutions was conducted using ICP-MS. In particular, samples were digested with diluted nitric acid and then injected to the ICP-MS and IC to analyse the anions and cations.

Impurity rejection (measured by ICP-MS) was analysed by comparing the concentration of the given impurity in the feedstock solution to the concentration of that impurity in the solution after the extraction step was completed.

### Results

Lithium extraction experiments over seven cycles showed a mean lithium uptake capacity of 6.4±0.7 mg/g (mg of Li+ per g of HTO within the membrane), as shown by Figure a). The standard deviation represents 11.1% of the mean value and while the trendline shows a slight positive gradient, this is likely due to experimental variation. Nevertheless, it shows the stability of the lithium uptake performance over several cycles. Figure b) shows the mean impurity rejection values for Ca²⁺, Na⁺, Mg²⁺ and K⁺ ions over the seven cycles which were 98.67%±2.65, 99.13%±0.68, 97.64%±2.74 and 98.91%±0.78, respectively. These high rejection values indicate a higher selectivity of the LIS for Li⁺.

These results therefore demonstrate that the present combination can provide a material which effectively and selectively extracts Li⁺ from a feedstock, and in particular one which continues to operate effectively over many cycles and/or at high temperatures.

1. A lithium-ion exchange material for direct lithium extraction, comprising
(i) a polyethersulfone matrix material; and, within the matrix,
(ii) lithium titanium oxide and/or hydrogen titanium oxide derived from lithium titanium oxide.

2. The lithium-ion exchange material of claim 1 wherein the lithium titanium oxide and/or hydrogen titanium oxide is present as particles having an average particle size of ≤50 μm.

3. The lithium-ion exchange material of any one of the preceding claims wherein the total content of lithium titanium oxide and hydrogen titanium oxide is from 20 wt % to 50 wt %.

4. The lithium-ion exchange material of any one of the preceding claims wherein the content of polyethersulfone is from 50 wt % to 80 wt %.

5. The lithium-ion exchange material of any one of the preceding claims wherein the content of lithium titanium oxide and hydrogen titanium oxide is from 20% to 100% the content of polyethersulfone by mass.

6. A membrane for direct lithium extraction comprising the lithium-ion exchange material of any one of the preceding claims.

7. The membrane according to claim 6 wherein the membrane is porous.

8. The membrane according to claim 7 wherein the porosity of the membrane is ≥60%

9. The membrane according to claim 7 or 8 wherein the mean pore diameter is ≤2 μm

10. The membrane of any one of claims 6 to 9 wherein the membrane is a hollow fiber membrane or in the form of beads.

11. The membrane of claim 10 wherein the membrane is a hollow fiber membrane having a wall thickness from 10 μm to 200 μm.

12. A method of direct lithium extraction from a lithium-containing feedstock solution, the method comprising:
(i) an extraction step, in which the lithium-containing feedstock solution is contacted with a lithium ion-exchange material, whereby the lithium ion-exchange material is loaded with lithium ions; and
(ii) a release step, in which a release solution comprising a protic acid is contacted with the lithium ion-exchange material, whereby lithium ions are released from the lithium ion-exchange material into the release solution;
wherein the lithium ion-exchange material is the lithium-ion exchange material of any one of claims 1 to 5 or the membrane of any one of claims 6 to 11.

13. The method of claim 12 wherein the extraction step and/or the release step are conducted at a temperature from 25° C. to 70° C.
